(19) United States
(12) Patent Application Publication
(10) Pub. No.: US 2012/0063469 A1
(43) Pub. Date: Mar. 15, 2012

(54) SCHEDULING DEVICE AND SCHEDULING METHOD

(76) Inventors: Takashi Iwai, Ishikawa (JP); Akihiko Nishio, Kanagawa (JP); Daichi Imamura, Kanagawa (JP); Kenichi Miyoshi, Kanagawa (JP); Megumi Ichikawa, Kanagawa (JP); Yoshihiko Ogawa, Kanagawa (JP); Sadaki Futagi, Ishikawa (JP)

(21) Appl. No.: 13/256,591

(22) PCT Filed: Mar. 15, 2010
(86) PCT No.: PCT/JP2010/001839

§ 371 Date: Sep. 14, 2011

(30) Foreign Application Priority Data
Mar. 16, 2009 (JP) 2009-063030

(51) Int. Cl. H04L 12/66

(52) U.S. Cl. 370/463

(57) ABSTRACT

Provided are a scheduling device and a scheduling method, in which the amount of signaling of frequency resource allocation information can be reduced while the system throughput is maintained. In a base station device (100), a scheduling unit (113) selects, as an allocation resource for a terminal to which resources are to be allocated, at most one cluster band in each of a plurality of allocatable ranges set within a system band and generates allocation resource information including information relating to the selected cluster, and an encoding unit (114), a modulation unit (115), and a transmission RF unit (116) which serve as a transmission means transmit the allocation resource information generated by the scheduling unit (113) to the terminal to which the resources are to be allocated. Among the plurality of allocatable ranges, a first allocatable range is the entire system band, while a second allocatable range is a low frequency-side band or a high frequency-side band when the system band is divided into halves.

### TECHNICAL FIELD

The present invention relates to a scheduling apparatus and a scheduling method.

### BACKGROUND ART

For an uplink channel of LTE-Advanced, which is an evolved version of 3rd generation partnership project long-term evolution (3GPP LTE), using “non-contiguous frequency transmission” in addition to contiguous frequency transmission, is under consideration to improve the sector throughput performance (see Non-Patent Literature 1).

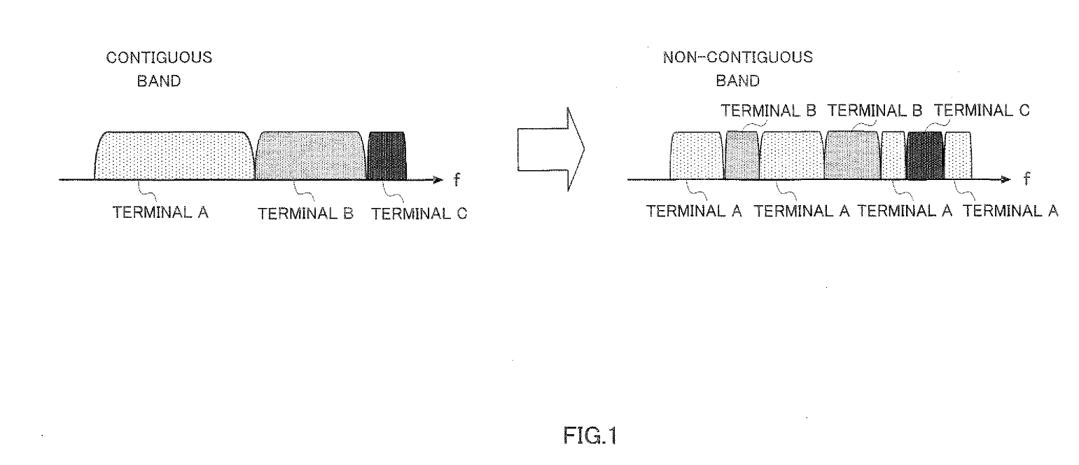

Non-contiguous frequency transmission is a method of transmitting a data signal and a reference signal by assigning such signals to non-contiguous frequency bands, which are dispersed in a wide range of band. As shown in FIG. 1, in non-contiguous frequency transmission, it is possible to assign a data signal and a reference signal to discrete frequency bands. Therefore, in non-contiguous frequency transmission, compared to contiguous frequency transmission, flexibility in assigning a data signal and a reference signal to frequency bands in each terminal increases. By this means, it is possible to gain greater frequency scheduling effects.

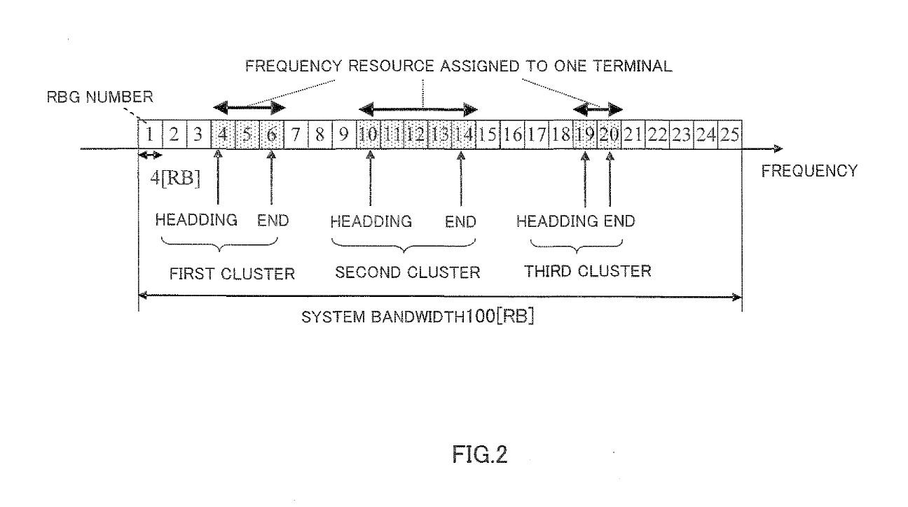

Here, as a method of reporting frequency resource assignment information for non-contiguous frequency transmission, there is a method of performing assignment in the non-contiguous band by transmitting a plurality of two pieces of frequency resource assignment information for contiguous band assignment including a heading resource number and an end resource number and combining those pieces of frequency resource assignment information (see Non-Patent Literature 2). As shown in FIG. 2, a base station assigns a resource block group (RBG) number per predetermined RB assignment unit [RB] (per 4 [RBs] in FIG. 2), and, for each contiguous band (hereinafter also referred to as “cluster band”), reports the heading RBG number and the end RBG number (hereinafter also referred to as “cluster band information”) to a terminal subject to frequency assignment. Further, a resource block (RB) is the smallest unit for assigning frequency to data, and one RB is formed with twelve subcarriers. In this reporting method, when the maximum assignment bandwidth is represented by N_{RB} [RB] and the RB assignment unit by P [RB], the number of clusters by N_{Cluster}, the number of signaling bits required for frequency resource assignment information can be represented by equation 1 below.

[1]

Number of signaling bits=┌ log₂(┌N_{RB}/P┐+1C₂)┐·N_{Cluster}[bits] (Equation 1)

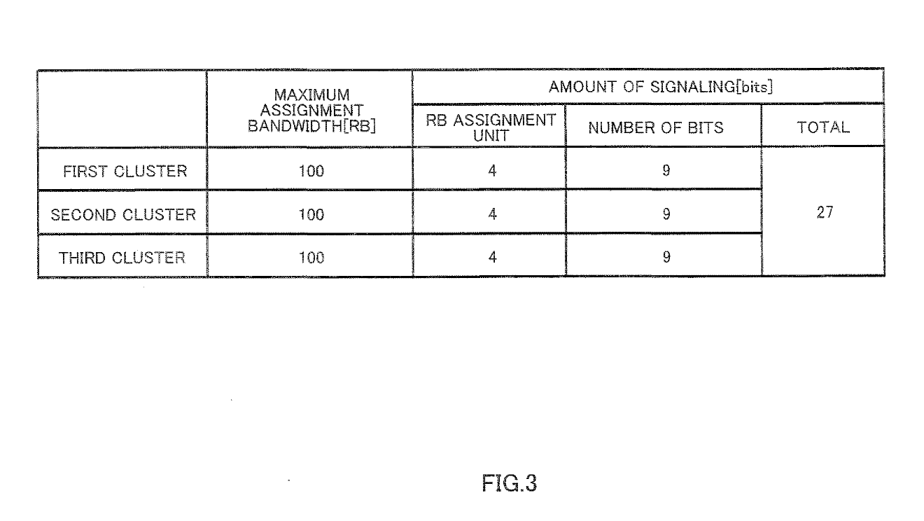

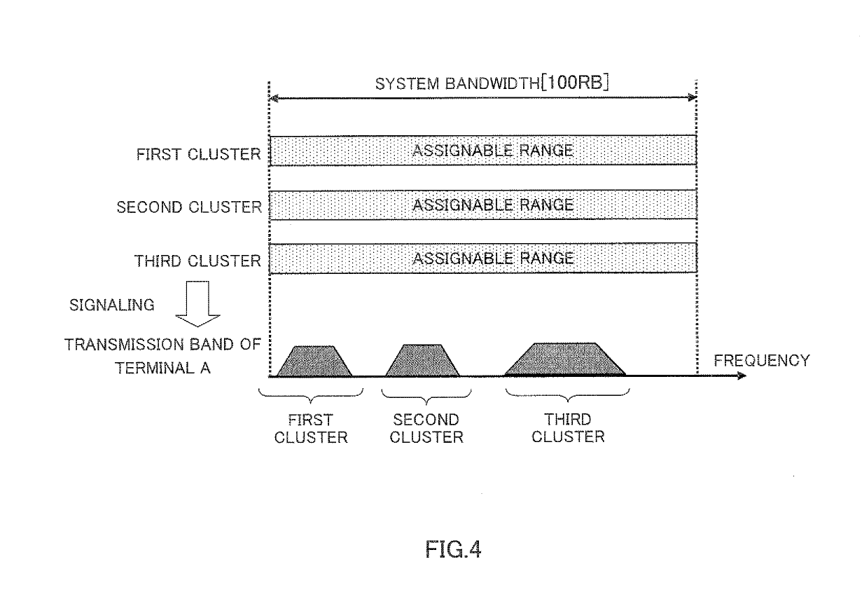

Therefore, as shown in FIG. 3, when N_{RB}=100 [RBs], P=4, and N_{Cluster}=3 are set, the number of signaling bits is 27 bits. As shown in FIG. 4, when the system bandwidth is 100 [RBs], the range of the bandwidth that can be assigned to each cluster is from RBG#1 to RGB#25, and by reporting the heading RBG number and the end RBG number within that range, it is possible to report frequency resource assignment information per cluster, to a terminal.

The terminal can transmit uplink data according to the frequency resource assignment information reported from the base station as described above.

### CITATION LIST

### Non-Patent Literature

### NPL 1

3GPP R1-090257, Panasonic, “System performance of uplink non-contiguous resource allocation”

### NPL 2

3GPP R1-073535, Samsung, “Comparison of Downlink Resource Allocation Indication Schemes”

### NPL 3

3GPP R1-084398, Qualcomm Europe, “Aspects to consider for DL transmission schemes of LTE-A”

### SUMMARY OF INVENTION

### Technical Problem

However, the conventional non-contiguous frequency transmission method has a problem that the number of signaling bits required to report frequency resource assignment information is large.

That is, as shown in above equation 1, the number of signaling bits increases in proportion to number of clusters N_{Cluster}. Therefore, when the number of signaling bits is reduced simply by making the maximum assignment bandwidth N_{RB} [RB] narrow, it is not possible to perform fine-tuned assignment processing such as assigning a band, in which a terminal has better reception quality, to that terminal, so that, consequently, flexibility in frequency scheduling lowers and system throughput performance deteriorates. Further, even if the number of signaling bits is reduced simply by increasing RB assignment unit P, deterioration of system throughput is caused in the same way.

It is therefore an object of the present invention to provide a scheduling apparatus and a scheduling method for is making it possible to maintain system throughput and reduce the amount of signaling of frequency resource assignment information.

### Solution to Problem

One aspect of a scheduling apparatus according to the present invention employs a configuration to comprise a scheduler that selects a maximum of one cluster band for each of a plurality of assignable ranges set in a system band, as assignment resources for a terminal subject to resource assignment, and generates assignment resource information containing information about the selected cluster band; and a transmission section that transmits the generated assignment resource information to the terminal subject to resource assignment; wherein while a first assignable range is the whole system band, a second assignable range is a partial band of the system band.

One aspect of a scheduling method according to the present invention employs a configuration to select a maximum of one cluster band for each of a plurality of assignable ranges set in a system band, as assignment resources for a terminal subject to resource assignment, and generate assignment resource information containing information about the selected cluster band; and while a first assignable range is the whole system band, a second assignable range is a partial band of the system band.

### Advantageous Effects of Invention

According to the present invention, it is possible to provide a scheduling apparatus and a scheduling method for making it possible to maintain system throughput and reduce the amount of signaling of frequency resource assignment information.

### ADVANTAGEOUS EFFECTS OF INVENTION

FIG. 1 shows non-contiguous frequency transmission;

FIG. 2 shows a method of reporting frequency resource assignment information for non-contiguous frequency transmission;

FIG. 3 shows a method of reporting frequency resource assignment information for non-contiguous frequency transmission;

FIG. 4 shows a method of reporting frequency resource assignment information for non-contiguous frequency transmission;

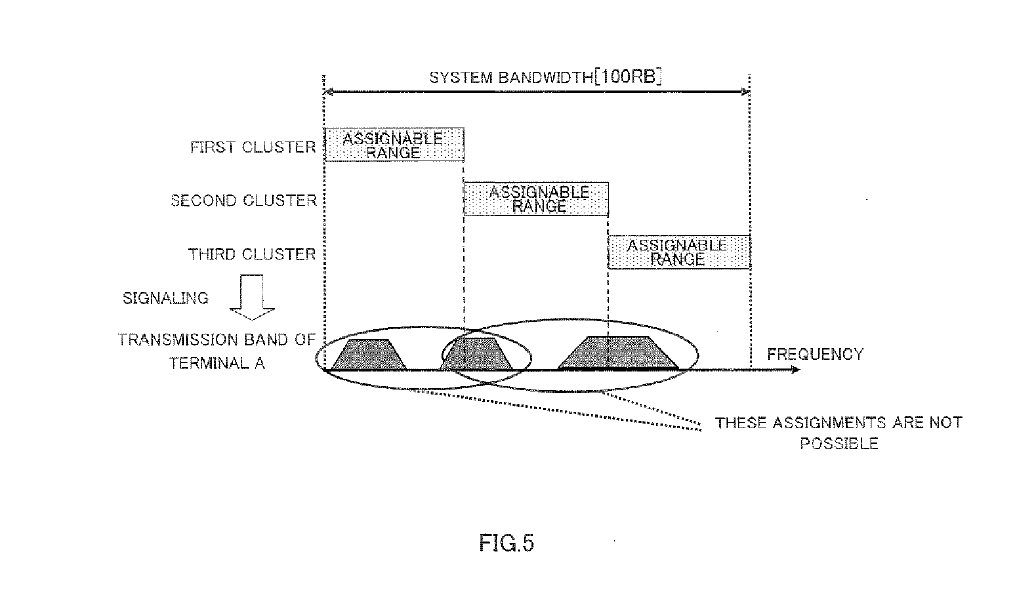

FIG. 5 shows a method of reducing the number of signaling bits by limiting a range that can be assigned to an arbitrary terminal subject to assignment;

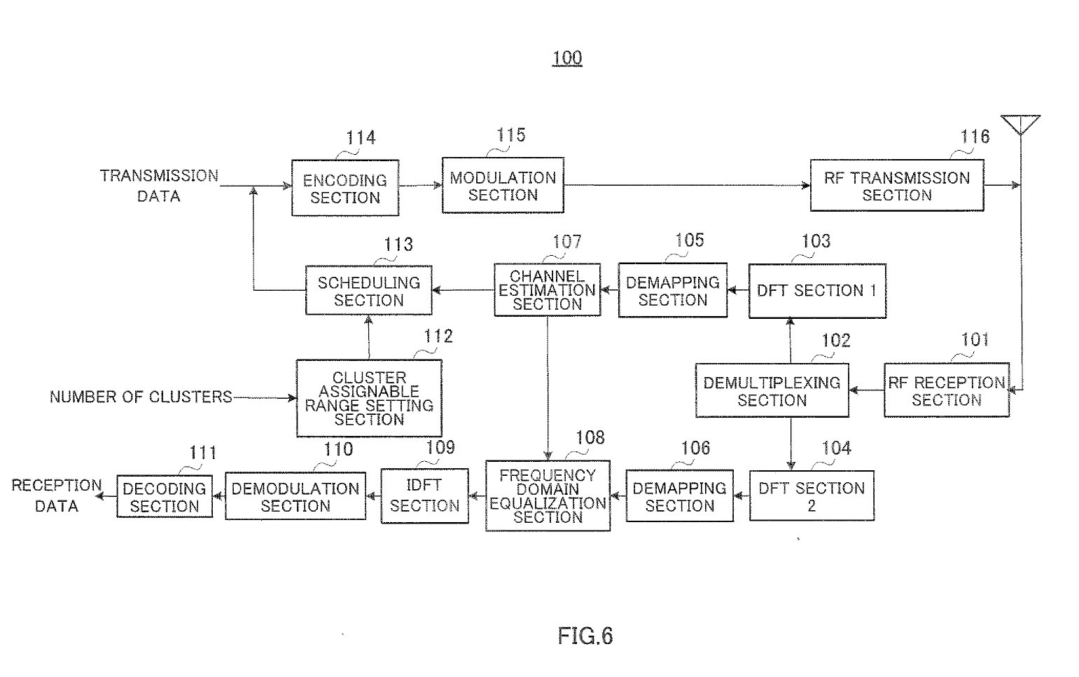

FIG. 6 is a block diagram showing a configuration of a base station apparatus according to Embodiment 1 of the present invention;

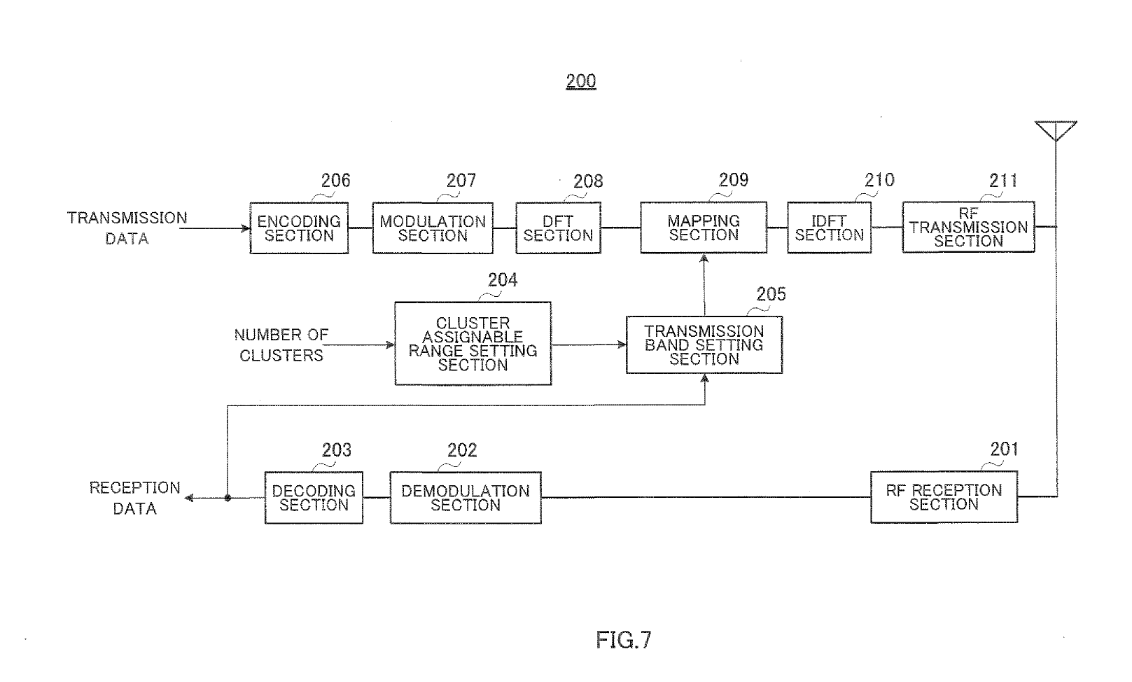

FIG. 7 is a block diagram showing a configuration of a terminal apparatus according to Embodiment 1 of the present invention;

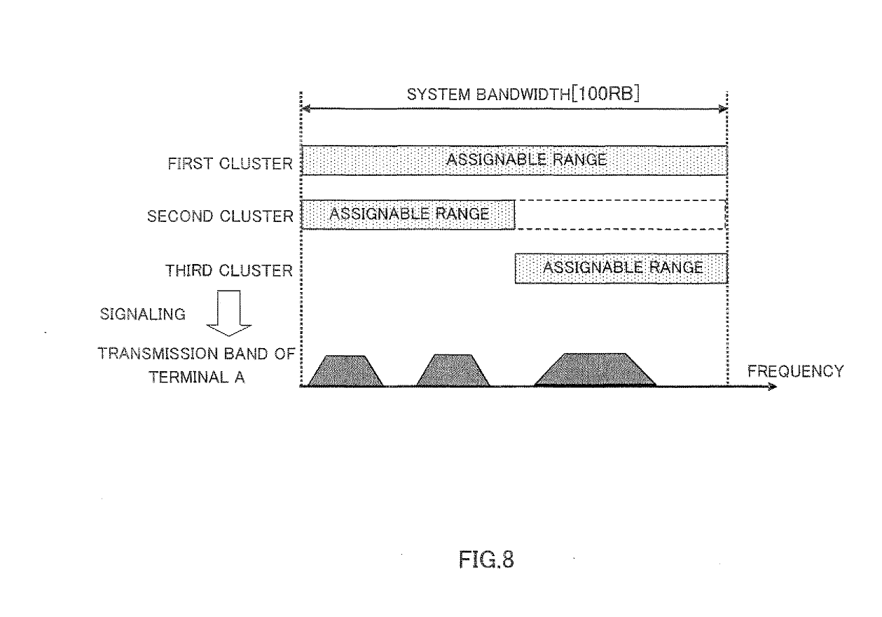

FIG. 8 shows an assignable range group;

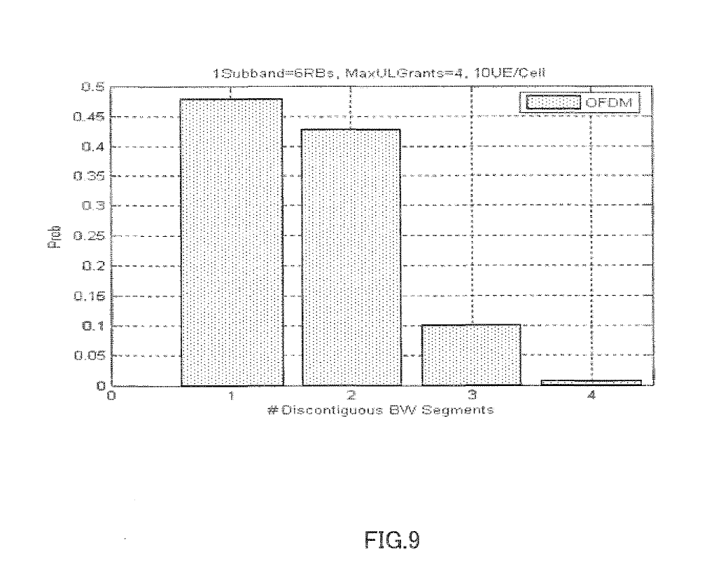

FIG. 9 shows a probability distribution obtained by system level simulation, indicating the number of clusters required per terminal;

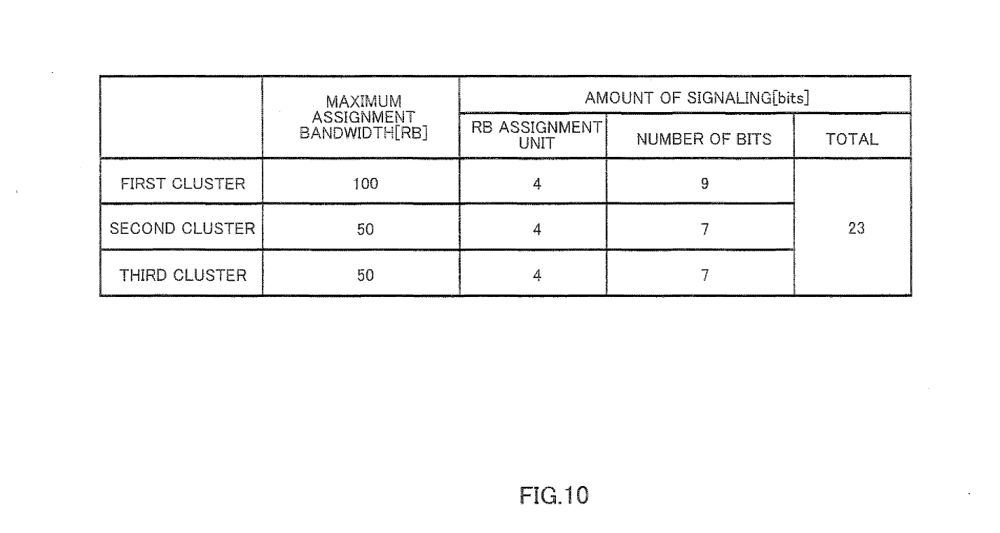

FIG. 10 shows the number of signaling bits when three clusters are assigned by the assignable range group shown in FIG. 8;

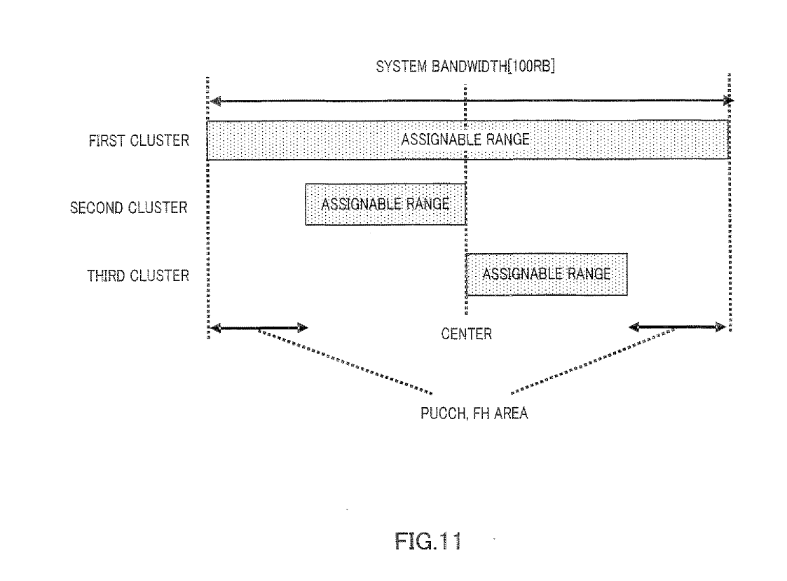

FIG. 11 shows an assignable range group when the assignable range for the second cluster and the assignable range for the third cluster are set in the part not including both ends of the system band;

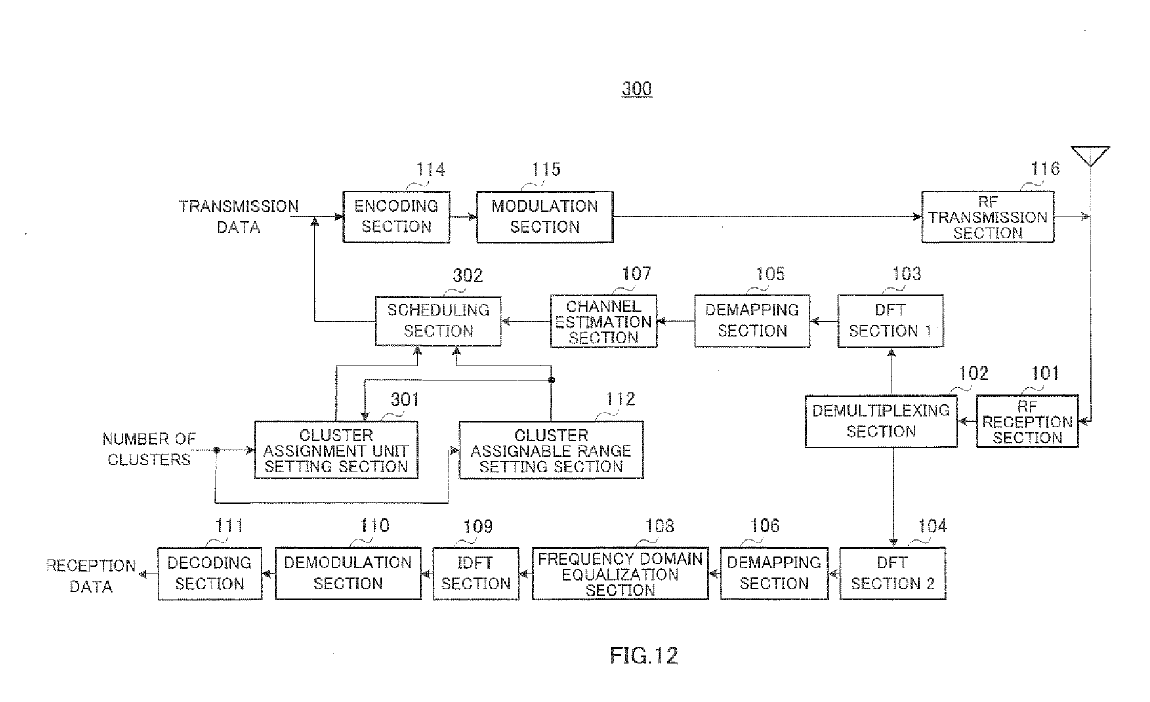

FIG. 12 is a block diagram showing a configuration of a base station apparatus according to Embodiment 2 of the present invention;

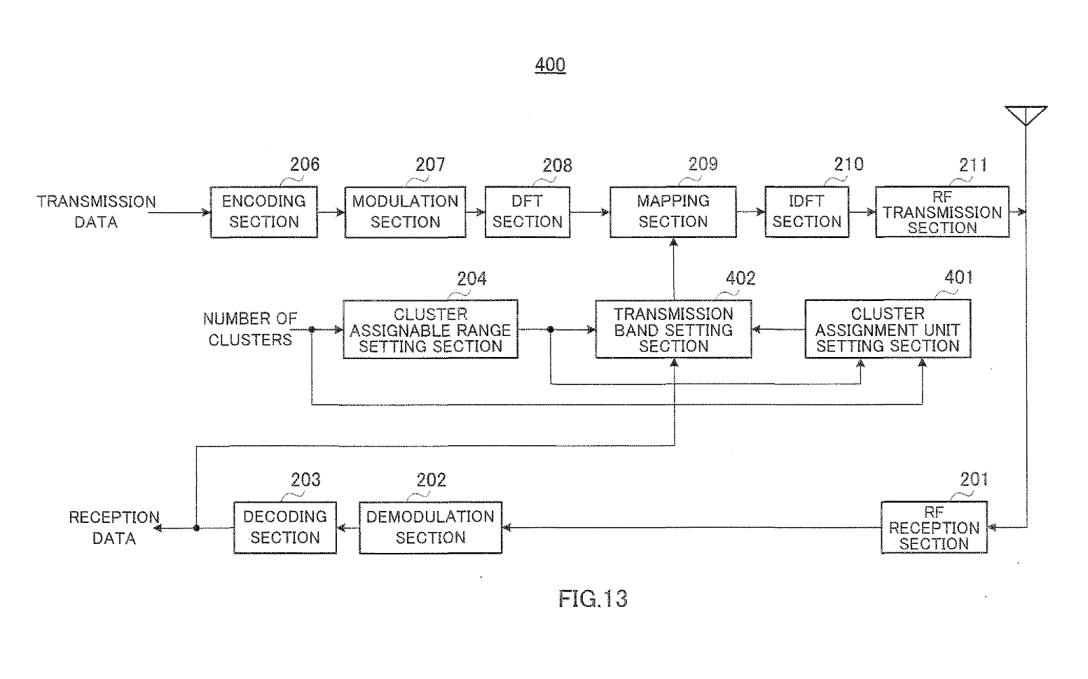

FIG. 13 is a block diagram showing a configuration of a terminal apparatus according to Embodiment 2 of the present invention;

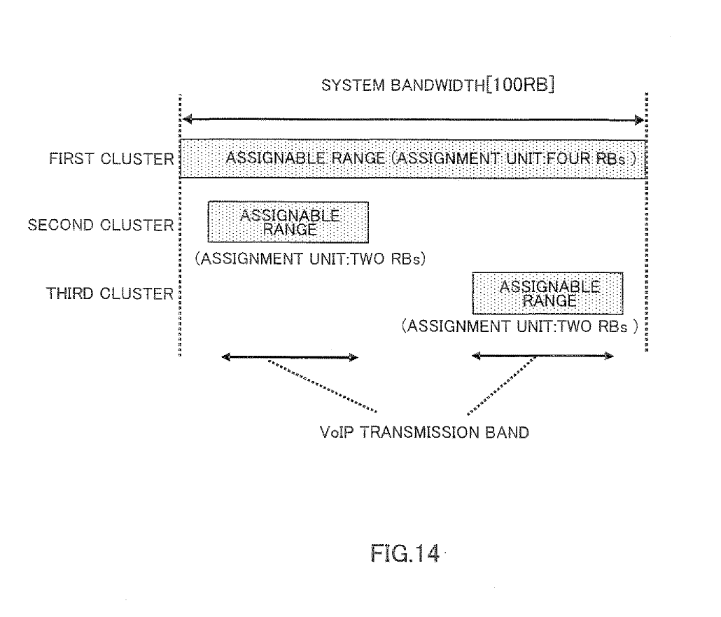

FIG. 14 shows an assignable range group;

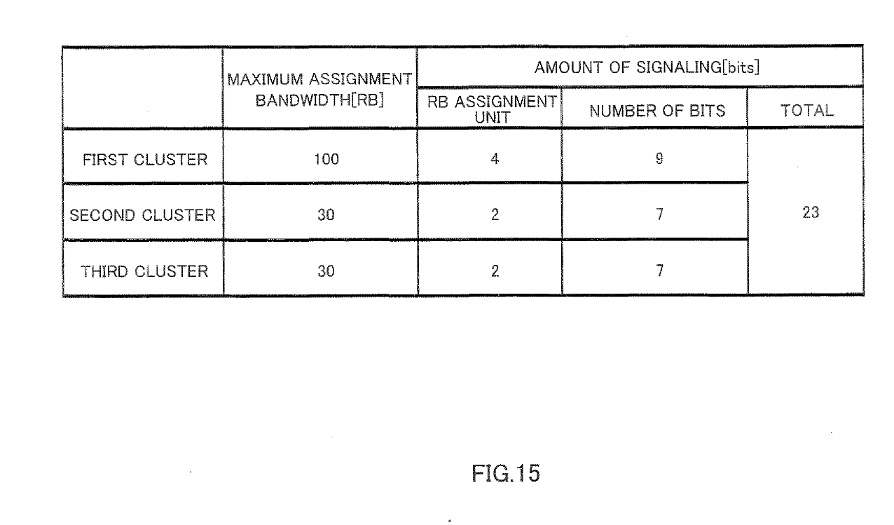

FIG. 15 shows the number of signaling bits when three clusters are assigned by the assignable range group shown in FIG. 14;

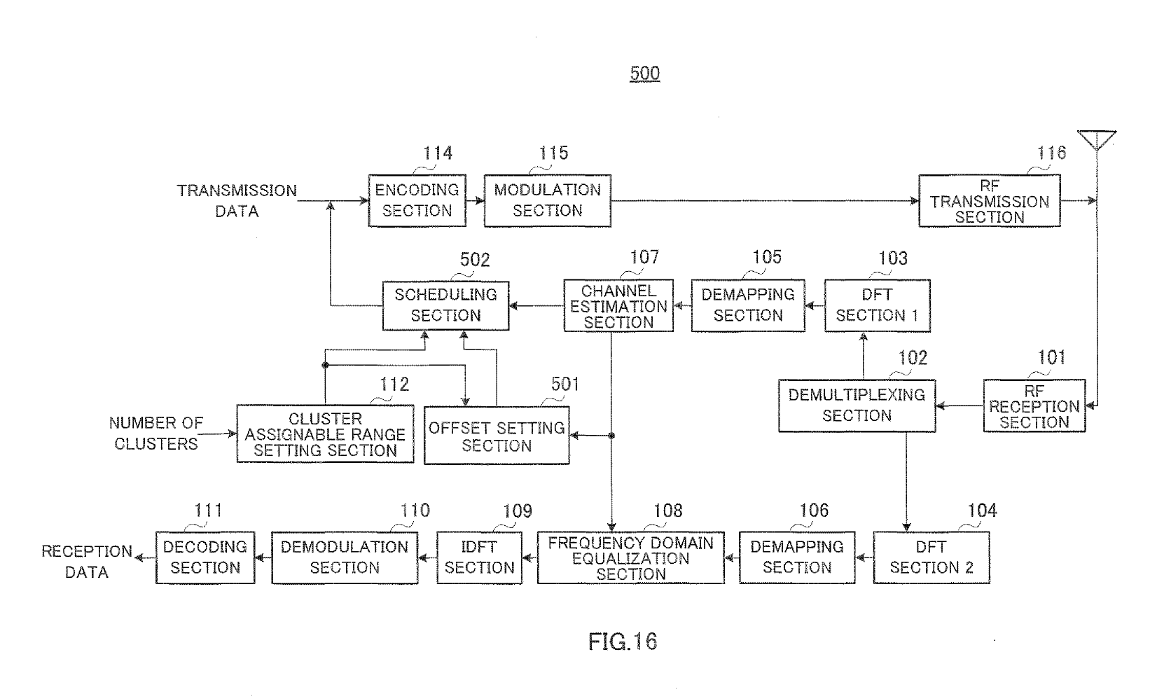

FIG. 16 is a block diagram showing a configuration of a base station apparatus according to Embodiment 3 of the present invention;

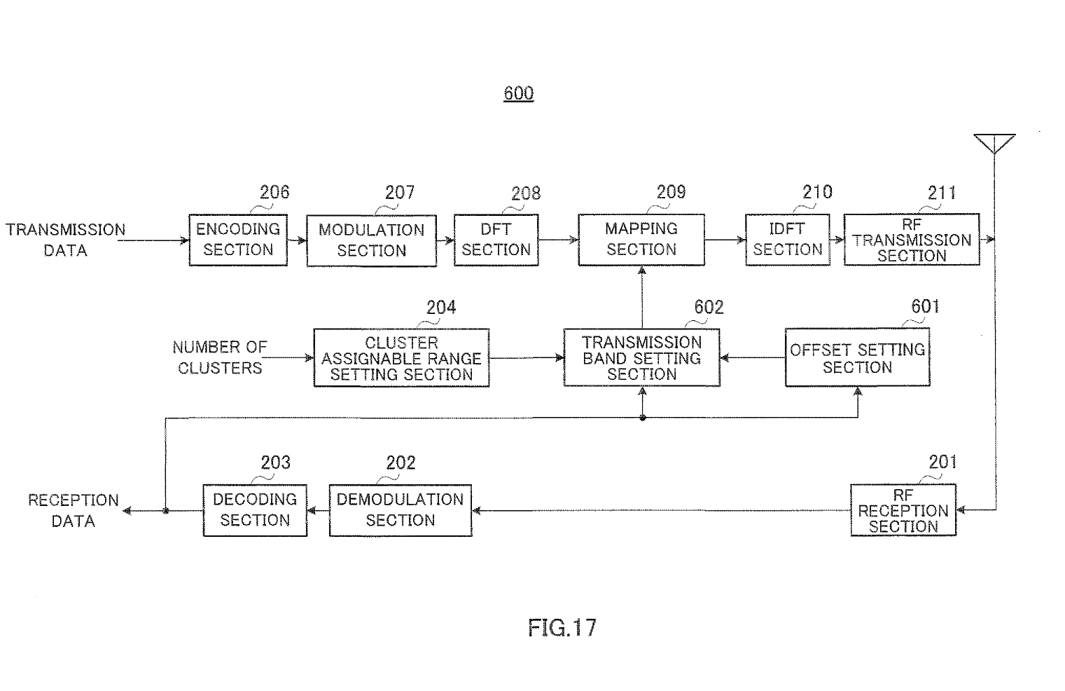

FIG. 17 is a block diagram showing a configuration of a terminal apparatus according to Embodiment 3 of the present invention;

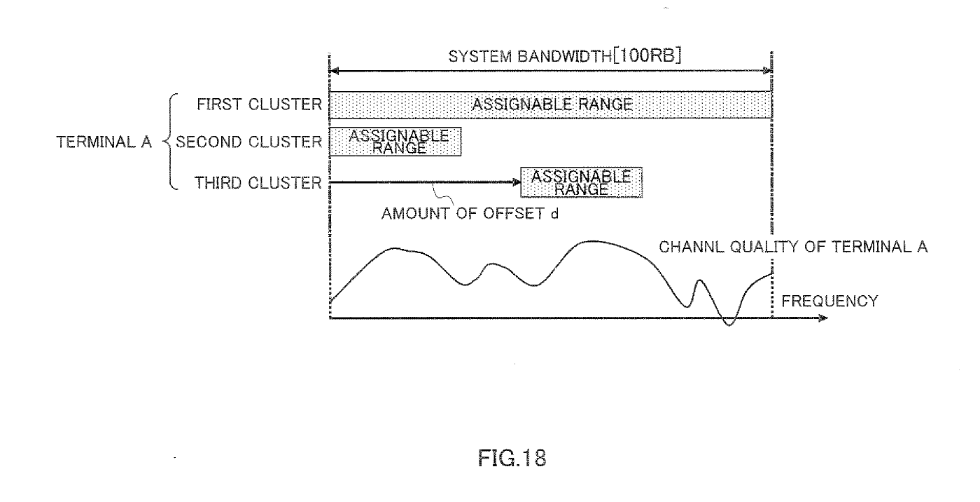

FIG. 18 shows an operation of a base station apparatus;

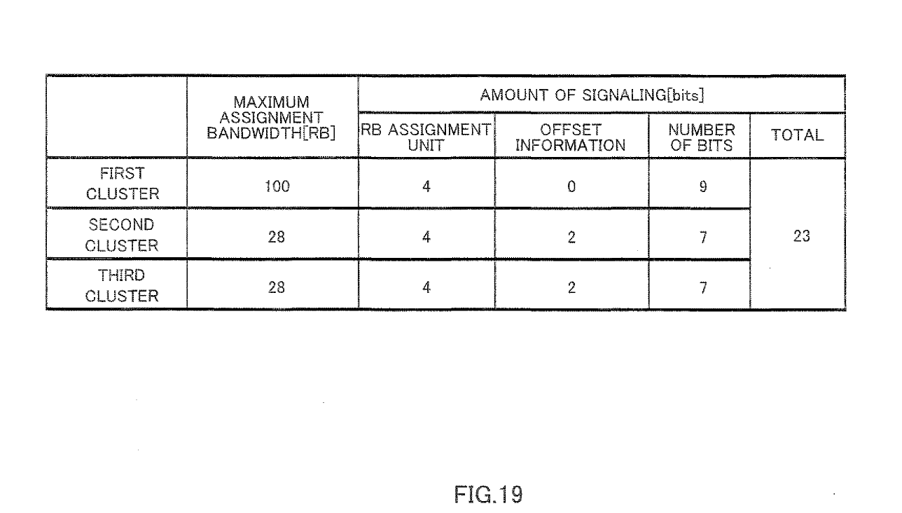

FIG. 19 shows the number of signaling bits when three clusters are assigned by the assignable range group shown in FIG. 18;

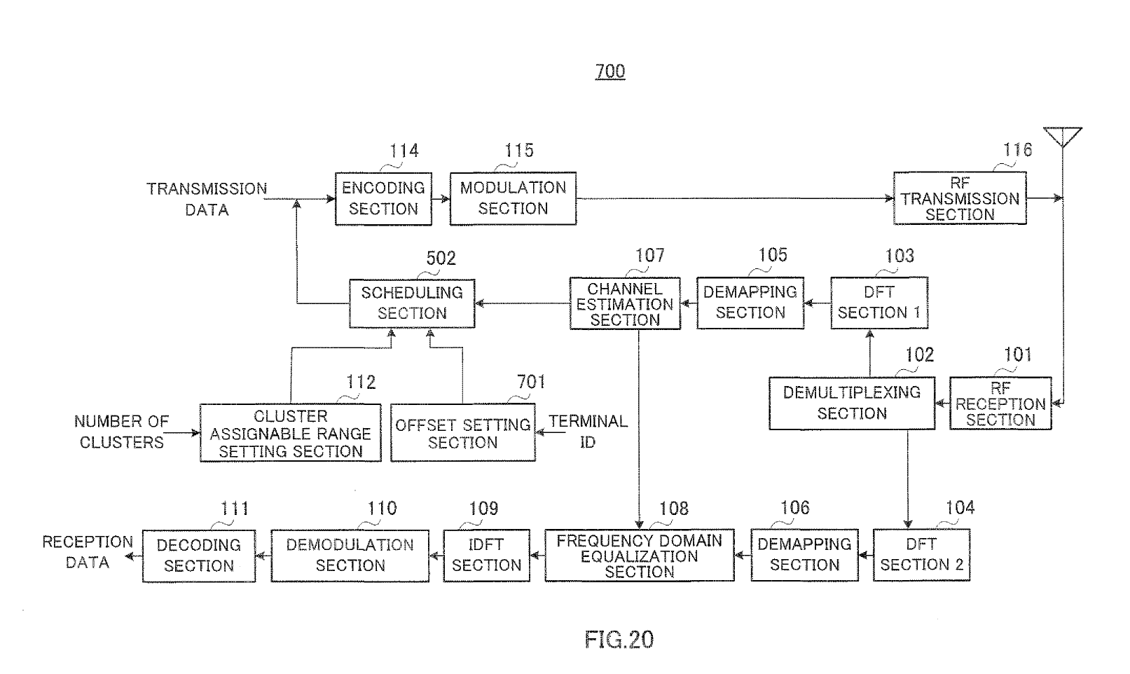

FIG. 20 is a block diagram showing a configuration of a base station apparatus according to Embodiment 4 of the present invention;

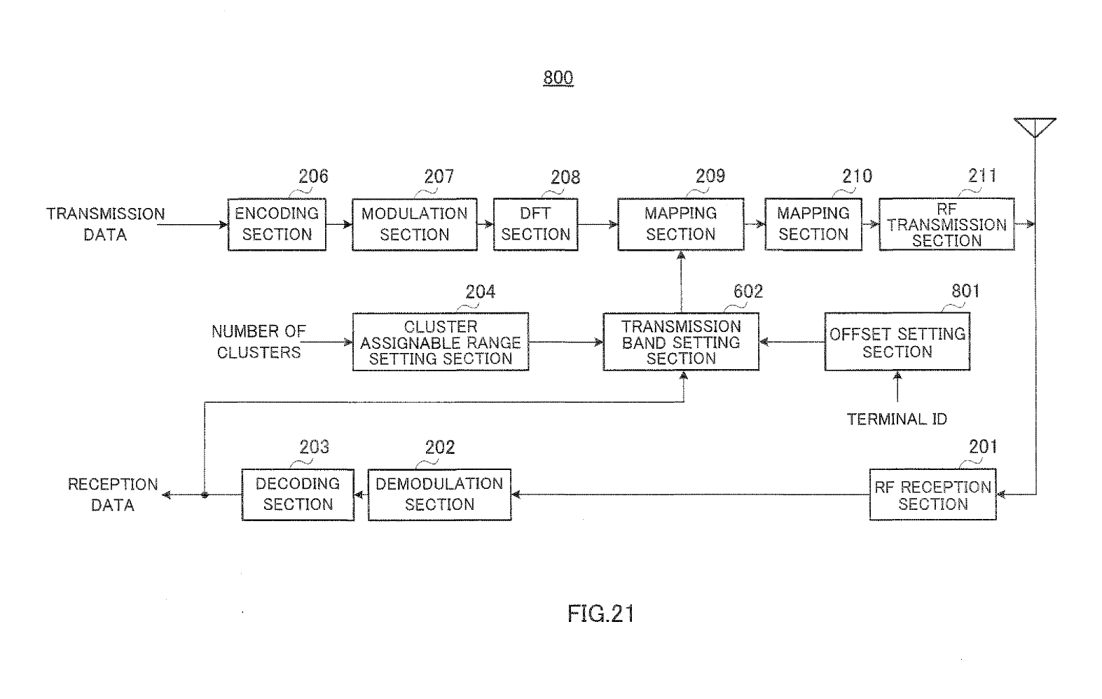

FIG. 21 is a block diagram showing a configuration of a terminal apparatus according to Embodiment 4 of the present invention;

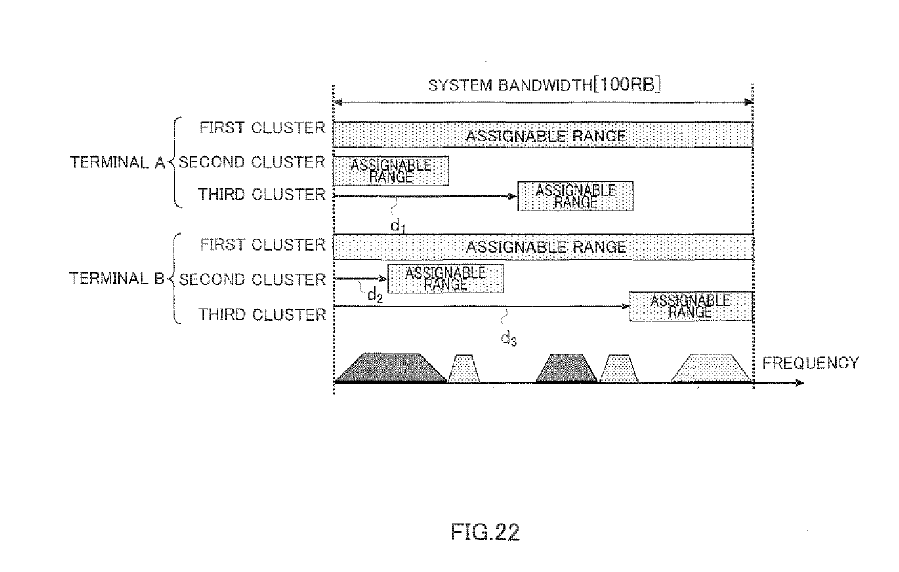

FIG. 22 shows an operation of a base station apparatus;

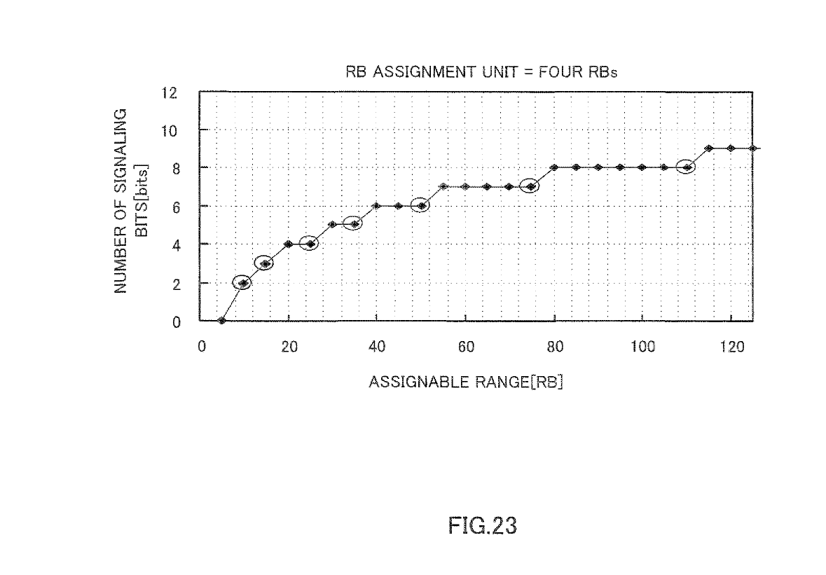

FIG. 23 shows a bandwidth of the assignable range corresponding to the number of signaling bits required per cluster;

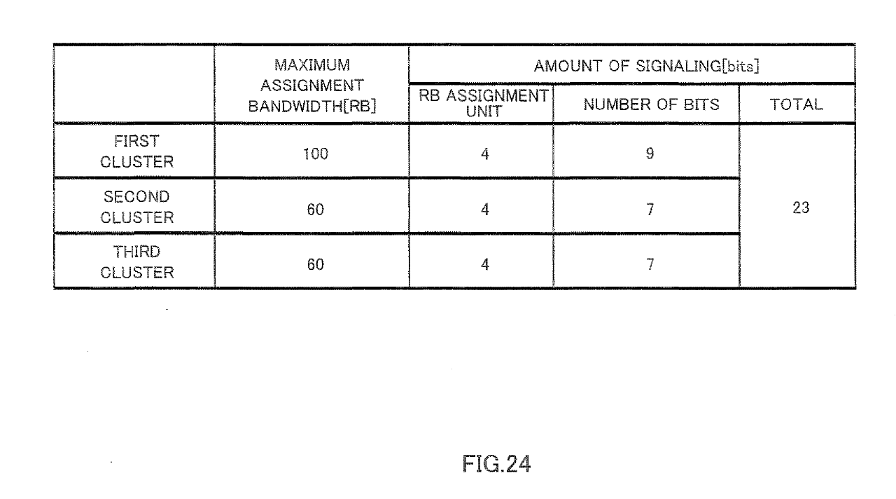

FIG. 24 shows an optimal bandwidth of the second assignable range when the number of signaling bits is set as the target number of signaling bits under the same condition as when the number of signaling bits shown in FIG. 10 is determined;

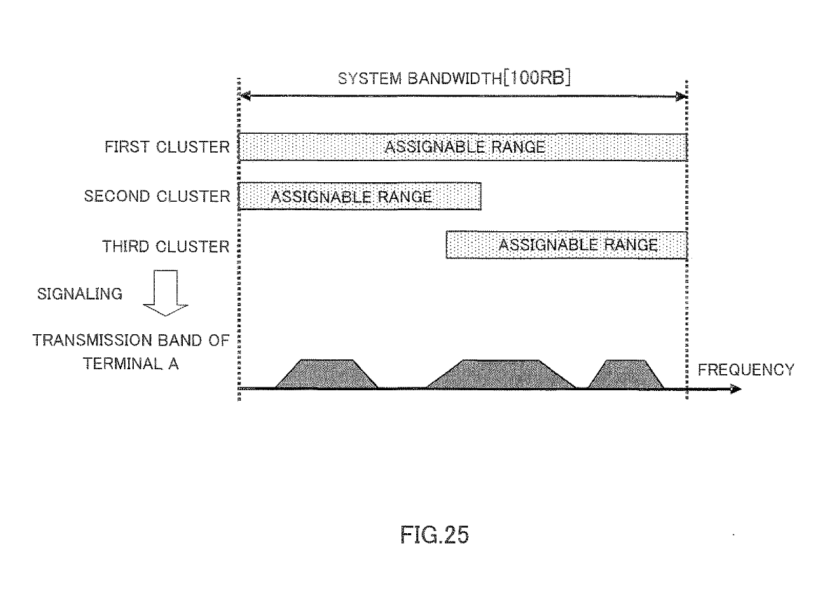

FIG. 25 shows the assignable range group to which the optimal bandwidths shown in FIG. 24 are applied;

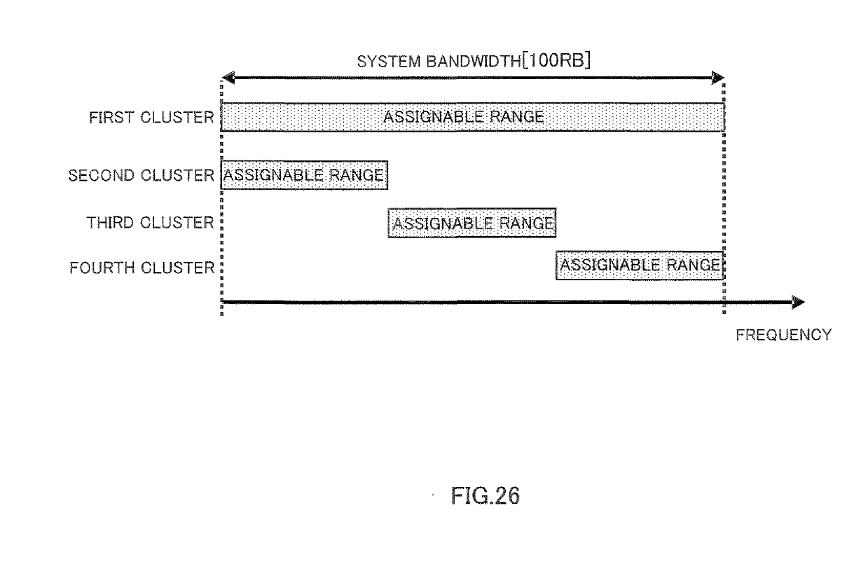

FIG. 26 shows an example of an assignable range group when the maximum number of clusters is four;

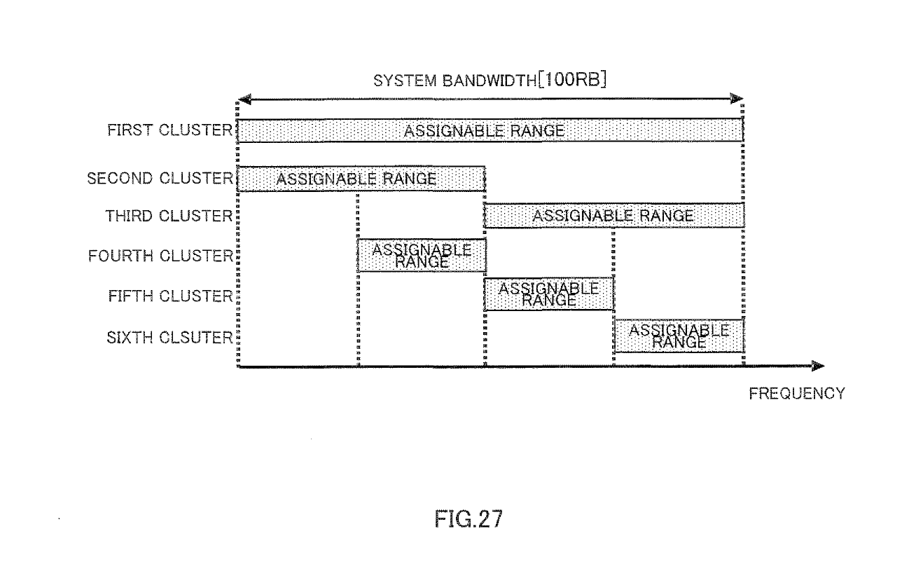

FIG. 27 shows an example of an assignable range group when the maximum number of clusters is six;

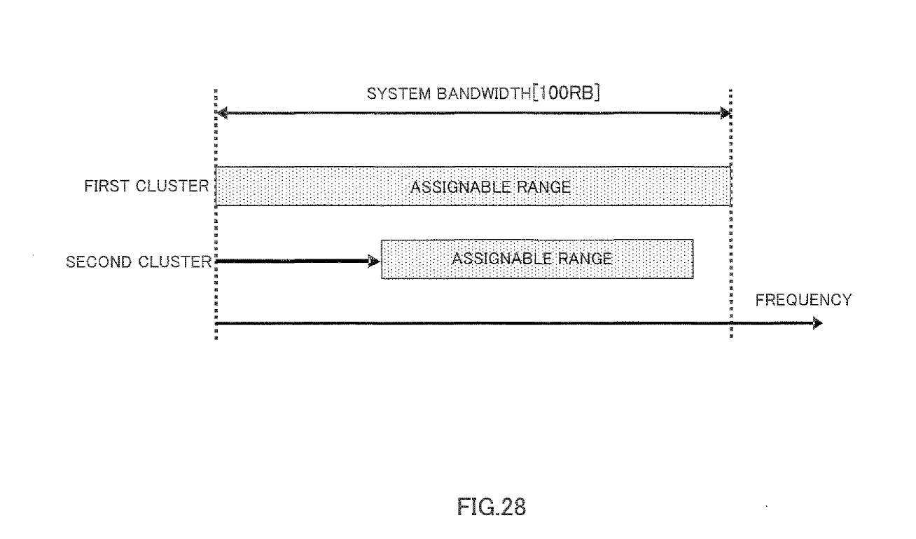

FIG. 28 shows an example of an assignable range group when the maximum number of clusters is two;

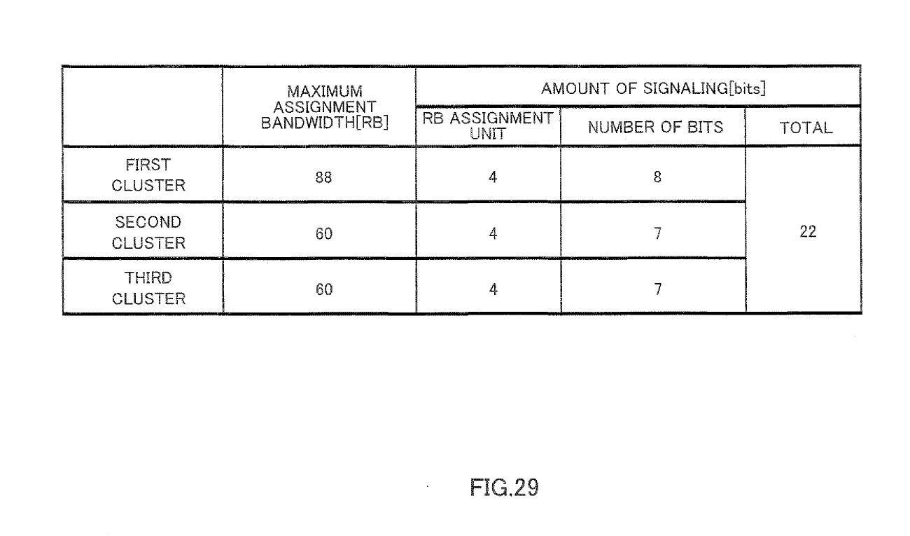

FIG. 29 shows an optimal bandwidth of the assignable range for the first cluster when the target number of signaling bits is set eight; and

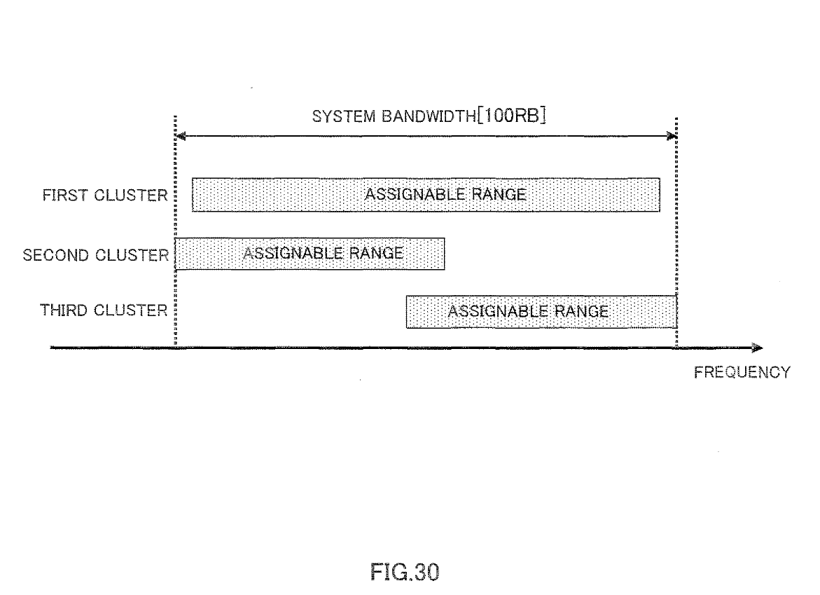

FIG. 30 shows an example of arrangement of the assignable band for the first cluster when the optimal bandwidth is eighty eight RBs.

### DESCRIPTION OF EMBODIMENTS

As a method of reducing the amount of signaling of frequency resource assignment information, it is possible to employ the following method. FIG. 5 shows a method of reducing the number of signaling bits by limiting the range that can be assigned to each cluster assigned to an arbitrary terminal subject to assignment (hereinafter also referred to as “assignable range”). That is, in FIG. 5, the bandwidth and the maximum assignment bandwidth N_{RB} of the assignable range for each cluster are set as small as 33 [RBs], and the assignable ranges for each cluster are arranged in a distributed manner in the system band. Frequency resource assignment information in each cluster (i.e. cluster band information) is also reported to a terminal subject to assignment, using two information of the heading RBG number and the end RBG number of the assignment resource, based on the RBG number that is numbered within each assignable range. By this means, it is possible to report one cluster band per one assignable range. In contrast, in the case of FIG. 5, for example, it is not possible to assign two or more cluster bands, as shown with circles, in one assignable range. Further, when a cluster band is assigned over the border between assignable ranges for adjacent clusters, it is necessary to use two pieces of cluster band information to report this cluster band to a terminal subject to assignment. Therefore, as shown in FIG. 5, when three assignable range are prepared, although a maximum of three cluster bands can be assigned to one terminal subject to assignment, the number of cluster bands that can be actually assigned is limited to two or smaller.

That is, simply by limiting the assignable range for each cluster, flexibility in assignment of cluster bands lowers and consequently there is a possibility that system throughput cannot be maintained.

In view of these problems, the inventors have made the present invention.

Now, embodiments of the present invention will be described in detail with reference to the accompanying drawings. In embodiments, the same parts will be assigned the same reference numerals and overlapping explanations will be omitted.

### Embodiment 1

FIG. 6 is a block diagram showing a configuration of base station apparatus 100 according to Embodiment 1 of the present invention. In FIG. 6, base station apparatus 100 as a scheduling apparatus includes RF reception section 101, demultiplexing section 102, DFT sections 103 and 104, demapping sections 105 and 106, channel estimation section 107, frequency domain equalization section 108, IDFT section 109, demodulation section 110, decoding section 111, cluster assignable range setting section 112, scheduling section 113, encoding section 114, modulation section 115, and RF transmission section 116.

RF reception section 101 performs reception processing, such as down-conversion and A/D conversion, on a signal received from terminal apparatus 200 (described later) via an antenna, and outputs the reception-processed signal to demultiplexing section 102.

Demultiplexing section 102 demultiplexes the signal input from RF reception section 101 to a pilot signal and a data signal. Then, demultiplexing section 102 outputs the pilot signal to DFT section 103 and outputs the data signal to DFT section 104.

DFT section 103 performs DFT processing on the pilot signal received from demultiplexing section 102 to convert a time domain signal into a frequency domain signal. Then, DFT section 103 outputs the pilot signal converted into a frequency domain to demapping section 105.

Demapping section 105 extracts a pilot signal corresponding to the transmission band of terminal apparatus 200 (described later) from the frequency-domain pilot signal received from DFT section 103, and outputs the pilot signal to channel estimation section 107.

Channel estimation section 107 estimates frequency variation in a channel (i.e. channel frequency response) and reception quality per frequency band, by performing correlation calculation on the reception pilot signal received from demapping section 105 and the transmission pilot signal that is known between base station apparatus 100 and terminal apparatus 200. Then, channel estimation section 107 outputs a channel estimation value, which is the result of this estimation, to frequency domain equalization section 108 and scheduling section 113.

DFT section 104 performs DFT processing on the data signal received from demulplexing section 102 to convert a time domain signal into a frequency domain signal. Then, DFT section 104 outputs the data signal converted into a frequency domain to demapping section 106.

Demapping section 106 extracts part of the data signal corresponding to the transmission band of terminal apparatus 200 from the signal received from DFT section 104, and outputs the extracted data signal to frequency domain equalization section 108.

Frequency domain equalization section 108 performs equalization processing on the data signal received from demapping section 106, using the channel estimation value (i.e. channel frequency response) received from channel estimation section 107. Then, frequency domain equalization section 108 outputs the signal obtained by equalization processing to IDFT section 109.

IDFT section 109 performs IDFT processing on the data signal input from frequency domain equalization section 108. Then, IDFT section 109 outputs the signal obtained by IDFT processing to demodulation section 110.

Demodulation section 110 performs demodulation processing on the signal received from IDFT section 109 and outputs the signal obtained by modulation processing to decoding section 111.

Decoding section 111 performs decoding processing on the signal received from demodulation section 110, and extracts the reception data.

Cluster assignable range setting section 112 holds information about the relationship between the assignable range applied to each of a plurality of clusters and the group of the assignable ranges corresponding to the number of clusters. Then, cluster assignable range setting section 112 outputs information about the group of assignable ranges corresponding to the number of clusters input (i.e. information about the bands of the assignable ranges that belong to that group (for example, the bandwidth and the position of frequency), to scheduling section 113.

Here, the upper limit value is set for the number of clusters to apply to a terminal subject to frequency assignment. Then, cluster assignable range setting section 112 receives as input the maximum number of clusters N (N is the maximum number of clusters that can be set for one terminal subject to assignment, which is predetermined by base station apparatus 100 or the system), which is the upper limit value, and outputs the information about the group of assignable ranges corresponding to that maximum number of clusters N, to scheduling section 113. That is, because the maximum number of clusters N is generally fixed, a fixed group is output to scheduling section 113. Details of this group of assignable ranges will be described later.

Scheduling section 113 assigns frequency resources to a terminal subject to frequency assignment, based on the number of clusters to assign to a terminal subject to assignment, reception quality information in the terminal subject to frequency assignment that is received from channel estimation section 107, and the assignable ranges forming the assignable range group received from cluster assignable range setting section 112. Specifically, scheduling section 113 determines a plurality of candidates for the cluster band based on the reception quality information received from channel estimation section 107, and, out of the plurality of cluster band candidates, selects a maximum of one cluster band candidate in each assignable range as an assignment cluster band. The upper limit value of the number of these assignment cluster bands is the maximum number of clusters N.

The cluster band information of the assignment cluster band thus assigned is reported to a terminal subject to assignment, as frequency scheduling information.

Encoding section 114 encodes transmission data containing the frequency scheduling information for a terminal subject to frequency assignment, and outputs the encoded data to modulation section 115.

Modulation section 115 modulates the encoded data received from encoding section 114 and outputs the modulated signal to RE transmission section 116.

RF transmission section 116 performs transmission processing, such as D/A conversion, up-conversion, and amplification, on the modulated signal received from modulation section 115, and transmits the obtained radio signal to terminal apparatus 200 from the antenna.

FIG. 7 is a block diagram showing a configuration of terminal apparatus 200 according to Embodiment 1 of the present invention. In FIG. 7, terminal apparatus 200 includes RF reception section 201, demodulation section 202, decoding section 203, cluster assignable range setting section 204, transmission band setting section 205, encoding section 206, modulation section 207, DFT section 208, mapping section 209, IDFT section 210, and RF transmission section 211.

RF reception section 201 performs reception processing, such as down-conversion and A/D conversion, on a signal received via an antenna, and outputs the reception-processed signal to demodulation section 202.

Demodulation section 202 performs equalization processing and demodulation processing on the signal received from RF reception section 201, and outputs the signal thus processed to decoding section 203.

Decoding section 203 performs decoding processing on the signal received from demodulation section 202 and extracts control data including reception data and frequency scheduling information.

Encoding section 206 encodes transmission data and outputs the obtained encoded data to modulation section 207.

Modulation section 207 modulates the encoded data received from encoding section 206 and outputs the data-modulated signal to DFT section 208.

DFT section 208 performs DFT processing on the data-modulated signal received from modulation section 207 and outputs the obtained frequency domain data signal to mapping section 209.

Mapping section 209 maps the data signal received from DFT section 208 to the assignment cluster band received from transmission band setting section 205, and outputs the obtained signal to IDFT section 210.

Cluster assignable range setting section 204 performs the same processing as cluster assignable range setting section 112. That is, cluster assignable range setting section 204 holds information about the relationship between the assignable range applied to each of a plurality of clusters and the group of assignable ranges corresponding to the number of clusters applied. Then, cluster assignable range setting section 204 outputs information about the group of assignable ranges corresponding to the number of clusters indicated by input information about the number of clusters (i.e. information about the bands of the assignable ranges that belong to that group (for example, the bandwidth and the position of frequency)), to transmission band setting section 205.

Transmission band setting section 205 extracts the frequency scheduling information contained in the control data received from decoding section 203. Then, transmission band setting section 205 designates the assignment cluster band based on the information about the group of assignable ranges received from cluster assignable range setting section 204 and the frequency scheduling information extracted, and outputs the designated assignment cluster band to mapping section 209.

IDFT section 210 performs IDFT processing on the signal received from mapping section 209. Then, IDFT section 210 outputs the signal obtained by IDFT processing to RF transmission section 211.

RF transmission section 211 performs transmission processing, such as D/A conversion, up-conversion, and amplification, on the signal received from IDFT section 210, and transmits the obtained radio signal to base station apparatus 100 from the antenna.

An operation of a radio communication system formed with base station apparatus 100 and terminal apparatus 200 having the above configuration will be described.

FIG. 8 shows an assignable range group. FIG. 8 shows a case where the maximum number of clusters N is 3. Therefore, FIG. 8 shows a total of three assignable ranges: the assignable range for the first cluster, the assignable range for the second cluster, and the assignable range for the third cluster. In FIG. 8, in particular, the assignable range for the first cluster matches the whole system band. Further, each of the assignable range for the second cluster and the assignable range for the third cluster is a partial band of the system band. Specifically, when the system band is divided into two, the lower-frequency side partial band is the assignable range for the second cluster and the higher-frequency side partial band is the assignable range for the third cluster.

Here, the reason that the upper limit can be set to the number of clusters is based on the probability of occurrence of the number of clusters required for non-contiguous assignment (see Non-Patent Literature 4). FIG. 9 shows a probability distribution obtained by system level simulation, indicating the number of clusters required per terminal. As shown in FIG. 9, the cases with the number of clusters used by a terminal being 1 or 2 accounts for the majority of the probability distribution. Usually, a scheduler of the base station that determines the frequency resource assignment for a terminal calculates the priority based on reception quality of each terminal in the cell, and assigns the terminal having the highest priority per assignment unit. In the current LTE system and LTE-A system, it is possible to assign the frequency resources of the system bandwidth of 100 [RBs] to terminals of 8 to 10 at the same time. In the vicinity of this condition, when the cluster bands having the top two priorities for each terminal are assigned, most of the system band will be occupied. Therefore, as shown in FIG. 9, the number of clusters that is actually assigned to a terminal is predominantly 1 or 2, and the probability that the number of clusters to be assigned is 3 or greater is approximately 10%.

FIG. 10 shows the number of signaling bits when three clusters are assigned by the assignable range group shown in FIG. 8. Here, the number of signaling bits is determined using equation 2 based on the same condition as the condition used when the number of signaling bits shown in FIG. 3 is determined (i.e. N_{RB}=100 [RBs], P=4, N_{Cluster}=3).

$$\begin{matrix}( Equation 2 ) & \\ Number of signaling bits = {\sum }_{m = 1}^{{N}_{Cluster}} ⌈ {log}_{2} ( {{⌈}_{{N}_{RB} ( m ) / P} ⌉}_{+ 1} {C}_{2} ) ⌉ [ bits ] & [ 2 ]\end{matrix}$$

Here, N_{RB}(m) represents the maximum assignment bandwidth [RB] of cluster m. Therefore, in the assignable range group shown in FIG. 8, N_{RB}(1)=100 [RBs], N_{RB}(2)=50 [RBs], and N_{RB}(3)=50 [RBs] are set.

As is clear from the comparison of FIG. 10 with FIG. 3, according to the present embodiment, among the ranges configuring the assignable range group, while only some of the assignable ranges are made match the whole system band, the remaining assignable ranges are limited to a partial band of the system band, so that it is possible to reduce the number of signaling bits compared to the conventional method.

When the assignable range group shown in FIG. 8 is used, scheduling section 113 performs the following assignment of frequency resources. That is, when the cluster band candidate is within the assignable range for the second cluster or the third cluster, that cluster band candidate can be the assignment cluster band for the second cluster or the third cluster. Further, because the assignable range for the first cluster matches the whole system band, the cluster band candidate within the assignable range for the second cluster or the third cluster can naturally be the assignment cluster band for the first cluster. On the other hand, the cluster band candidate is provided over the border between the second cluster and the third cluster, the problem described using FIG. 5 arises. However, according to the present embodiment, because the assignable range for the first cluster is made match the whole system band, flexibility in assignment will not be lowered by using this assignable range for the first cluster.

However, compared to the conventional method of assigning a cluster band shown in FIG. 2, there is a limitation that assignment cluster bands cannot be concentrated in the half of the system band, which is the lower frequency side or the higher frequency side. However, because the probability of the case in which the assignment cluster bands are concentrated in half of the system band, which is the lower frequency side or the higher frequency side is low, most of the influence by the above limitation on system throughput performance can be disregarded. That is, when there is little frequency correlation between channels (i.e. when frequency correlation between channels is observed only in as small range as an assignment unit), bands having high reception quality in a terminal and bands having low reception quality appear randomly in the whole system band. At this time, the probability that all three cluster bands are concentrated in half of the system band is approximately 25%. Further, as described in FIG. 8, the probability that three clusters are required is approximately 10%. Therefore, the probability of occurrence of the case in which three clusters are required and in which three cluster bands are concentrated in half of the system band is approximately 2.5%, which is a rare case. Further, when there is significant frequency correlation between channels, bands having high reception quality in a terminal and bands having low reception quality appear, each having a broad bandwidth. That is, because the bandwidth per cluster becomes broader, the probability that all three cluster bands are concentrated in half of the system band is expected to be smaller than 2.5%. As an environment in which there is significant frequency correlation between channels, an indoor environment or a microcell environment is possible. In this kind of environments, because significantly delayed waves are not generated, there are many cases where frequency correlation between channels is significant. Therefore, in particular, in the LTE-A system, in which the use environment is expected to be mainly an indoor environment or a microcell environment, even when the assignable range group according to the present embodiment is used, it is possible to disregard most of decrease of flexibility in assignment. As a result of this, even when the above-described limitation is set, it is possible to disregard most of the influence by the above-described limitation on system throughput performance.

As described above, according to the present embodiment, in base station apparatus 100, scheduling section 113 selects a maximum of one cluster band in each of a plurality of assignable ranges set in the system band, as assignment resources for a terminal subject to resource assignment, and generates assignment resource information containing information about the selected cluster; and encoding section 114, modulation section 115, and RF transmission section 116, as a transmission means, transmits the assignment resource information generated in scheduling section 113 to the terminal subject to resource assignment. Then, out of that plurality of assignable ranges, while the first assignable range is the whole system band, the second assignable range (corresponding to the assignable range for the second cluster or the assignable range for the third cluster in the above description) is the lower frequency band or the higher frequency band when the system band is divided into half.

By this means, it is possible to maintain system throughput by suppressing decrease in flexibility in assignment, and reduce the amount of signaling of frequency resource assignment information.

A case has been described with the above embodiment where the lower-frequency side partial band is the assignable range for the second cluster and the higher-frequency side partial band is the assignable range for the third cluster, when the system band is divided into two. However, the present invention is not limited to this, and it is possible to set the assignable range for the second cluster and the assignable range for the third cluster in the part not including both ends of the system band. In short, the present invention can be configured in any way as long as, while the first assignable range is the whole system band, the second assignable range that is different from the first assignable range (corresponding to the assignable range for the second cluster or the assignable range for the third cluster in the above description) is a partial band of the system band.

FIG. 11 shows an assignable range group when the assignable range for the second cluster and the assignable range for the third cluster are set in the part not including both ends of the system band. In the assignable range group shown in FIG. 11, compared to FIG. 8, bandwidths of the assignable range for the second cluster and the assignable range for the third cluster are set narrower, and it is possible to further reduce the number of signaling bits. In particular, in the LTE-A system, both ends of the system bandwidth are used as a transmission band for a control channel (PUCCH), or a transmission band for a channel subject to frequency hopping for which reporting of frequency assignment information is not required and for which the transmission band is determined in advance. Therefore, by using the assignable range group shown in FIG. 11 in the LTE-A system, although assignment to both ends of the system band is limited, flexibility in frequency assignment does not lower significantly, making it possible to maintain system throughput performance.

### Embodiment 2

A case will be described with Embodiment 2 where the resource assignment units of the assignable range for the second cluster and the assignable range for the third cluster are set smaller than the resource assignment unit of the assignable range for the first cluster.

FIG. 12 is a block diagram showing a configuration of base station apparatus 300 according to Embodiment 2 of the present invention. In FIG. 12, base station apparatus 300 includes cluster assignment unit setting section 301 and scheduling section 302.

Cluster assignment unit setting section 301 outputs the same number of cluster assignment units as the number of clusters input, to scheduling section 302. Specifically, cluster assignment unit setting section 301 holds information about the relationship between the assignable range applied to each of a plurality of clusters and the resource assignment unit in each assignable range. Then, cluster assignment unit setting section 301 receives the information about the assignable range group output from cluster assignable range setting section 112, and outputs the resource assignment unit corresponding to each of a plurality of assignable ranges forming that assignable range group, to scheduling section 302. The resource assignment unit here indicates the unit of frequency resources assigned to a terminal, i.e. assignment granularity.

Here again, the upper limit value is set for the number of clusters to apply to a terminal subject to frequency assignment. Therefore, the resource assignment unit corresponding to each of the plurality of assignable ranges forming the fixed group is output to scheduling section 302.

Scheduling section 302 has the same function as scheduling section 113. However, scheduling section 302 uses the resource assignment unit corresponding to an arbitrary assignable range received from cluster assignment unit setting section 301, as a standard unit used when selecting an assignment cluster band in that arbitrary assignable range (i.e. frequency resource assignment unit).

FIG. 13 is a block diagram showing a configuration of terminal apparatus 400 according to Embodiment 2 of the present invention. In FIG. 13, terminal apparatus 400 includes cluster assignment unit setting section 401 and transmission band setting section 402.

Cluster assignment unit setting section 401 performs the same processing as cluster assignment unit setting section 301. That is, cluster assignment unit setting section 401 outputs the same number of cluster assignment units as the number of clusters input, to transmission band setting section 402. Specifically, cluster assignment unit setting section 401 holds information about the relationship between the assignable range applied to each of the plurality of clusters and the resource assignment unit in each assignable range. Then, cluster assignment unit setting section 401 receives the information about the assignable range group output from cluster assignable range setting section 204, and outputs the resource assignment unit corresponding to each of the plurality of assignable ranges forming that assignable range group, to transmission band setting section 402.

Transmission band setting section 402 extracts frequency scheduling information contained in control data received from decoding section 203. Then, transmission band setting section 402 designates assignment cluster bands based on the information about the assignable range group received from cluster assignable range setting section 204, the resource assignment unit in each assignable range received from cluster assignment unit setting section 401, and the extracted frequency scheduling information, and outputs the designated assignment cluster bands to mapping section 209.

FIG. 14 shows an assignable range group. FIG. 14 shows a case where the maximum number of clusters N is three. Therefore, FIG. 14 shows a total of three assignable ranges: the assignable range for the first cluster, the assignable range for the second cluster, and the assignable range for the third cluster. In FIG. 14, in particular, the assignable range for the first cluster matches the whole system band. Each of the assignable range for the second cluster and the assignable range for the third cluster is a partial band of the system band.

Further, the first resource assignment unit used in the assignable range for the first cluster is different from the second resource assignment unit used in each of the assignable range for the second cluster and the assignable range for the third cluster. Specifically, the second resource assignment unit is smaller than the first resource assignment unit. Further, the size of the resource assignment unit is set according to the bandwidth of the assignable range to which the resource assignment unit is applied. That is, as the assignable range has a broader bandwidth, the resource assignment unit used in that assignable range is set larger.

FIG. 15 shows the number of signaling bits when three clusters are assigned by the assignable range group shown in FIG. 14. Here, the number of signaling bits is determined using equation 3 based on the same condition as the condition used when the number of signaling bits shown in FIG. 3 is determined (i.e. N_{RB}=100 [RBs], P=4, N_{Cluster}=3).

$$\begin{matrix}( Equation 3 ) & \\ Number of signaling bits = {\sum }_{m = 1}^{{N}_{Cluster}} ⌈ {log}_{2} ( {{⌈}_{{N}_{RB} ( m ) / P ( m )} ⌉}_{+ 1} {C}_{2} ) ⌉ [ bits ] & [ 3 ]\end{matrix}$$

Here, P(m) represents the assignment unit [RB] for cluster m. In the case of the assignable range group shown in FIG. 14, P(1)=4 [RBs], P(2)=2 [RBs], and P(3)=2 [RBs] are set. Further, N_{RB}(1)=100 [RBs], N_{RB}(2)=30 [RBs], and N_{RB}(3)=30 [RBs] are set.

As is clear from the comparison of FIG. 15 with FIG. 3, according to the present embodiment, among the ranges configuring the assignable range group, while only some of the assignable ranges are made match the whole system band, the remaining assignable ranges are limited to a partial band of the system band, so that it is possible to reduce the number of signaling bits compared to the conventional method, even when a difference is provided between the resource assignment unit of the first assignable range and the resource assignment unit of the second assignable range.

As described above, according to the present embodiment, in base station apparatus 300, scheduling section 302 sets the second resource assignment unit of the second assignable range (corresponding to the assignable range for the second cluster or the assignable range for the third cluster in the above description) smaller than the first resource assignment unit of the first assignable range (corresponding to the assignable range for the first cluster in the above description).

By this means, the resource assignment unit is set small in the second assignable range having a narrow bandwidth, so that, even when the assignment granularity is set dense, it is possible to suppress increase of the number of signaling bits. Further, because the resource assignment unit is set large in the first assignable range having a broad bandwidth and the assignment granularity is set coarse, is possible to suppress increase of the number of signaling bits required for the whole assignable range group.

Further, it is possible to vary the assignment granularity depending on the assignable range. For example, the transmission bandwidth of VoIP data for transmitting speech data of a terminal used in the LTE system or the LTE-A system is narrow, being one or two RBs. Therefore, small available resources of 1 or 2 RBs frequently appears in the band in which VoIP data is transmitted. Therefore, by assigning the cluster bands selected in the above-described second assignable range (corresponding to the assignable range for the second cluster or the assignable range for the third cluster in the above description) to VoIP data transmission, it is possible to perform fine-tuned resource assignment to VoIP data transmission. Therefore, because it is possible to assign a terminal to the above-described available resources, the utilization rate of the frequency resources increases, making it possible to improve system throughput performance.

### Embodiment 3

A case has been described with Embodiment 3 where a scheduling section adjusts the position of frequency of the second assignable range based on channel quality, and includes offset information about clearance between the adjusted position of frequency and the base position, in assignment resource information.

FIG. 16 is a block diagram showing a configuration of base station apparatus 500 according to Embodiment 3 of the present invention. In FIG. 16, base station apparatus 500 includes offset setting section 501 and scheduling section 502.

Offset setting section 501 determines the amount of offset of an assignable range having a narrower bandwidth than the bandwidth of the system band, out of a plurality of assignable ranges forming the assignable range group output from cluster assignable range setting section 112, based on the channel quality received from channel estimation section 107.

Scheduling section 502 adjusts the position of frequency of the assignable range having a narrower bandwidth than the bandwidth of the system band, out of a plurality of assignable ranges forming the assignable range group output from cluster assignable range setting section 112, based on the amount of offset received from offset setting section 501. Then, scheduling section 502 selects the assignment cluster bands using the assignable range group after adjustment of frequency, in the same way as scheduling section 113.

FIG. 17 is a block diagram showing a configuration of terminal apparatus 600 according to Embodiment 3 of the present invention. In FIG. 17, terminal apparatus 600 includes offset setting section 601 and transmission band setting section 602.

Offset setting section 601 extracts frequency scheduling information contained in the control data received from decoding section 203. Then, offset setting section 601 outputs the offset information contained in the extracted frequency scheduling information to transmission band setting section 602.

Transmission band setting section 602 adjusts the position of frequency forming the assignable range group received from cluster assignable range setting section 204, based on the input offset information. Then, transmission band setting section 602 converts the position of the assignment cluster band transmitted from the base station apparatus into the position of the assignable range after this adjustment of the position of frequency, and sets the assignment cluster band after the frequency position conversion in mapping section 209.

FIG. 18 shows an operation of base station apparatus 500. In FIG. 18, a curve shown at the lower side shows the channel quality with respect to the frequency for a terminal subject to assignment (described as “terminal A” in FIG. 18).

In base station apparatus 500, offset setting section 501 determines the amount of offset so that the band having good channel quality in a terminal subject to assignment is included in the assignable range. Here, the base position of the assignable range, which constitutes the standard when determining the amount of offset, is set at one end of the lower frequency side in the system band. In the channel quality shown in FIG. 18, the amount of offset applied to the assignable range for the second cluster is zero, and the amount of offset applied to the assignable range for the third cluster is d.

Then, scheduling section 502 adjusts the position of the assignable range based on the amount of offset determined in offset setting section 501, and includes information about the amount of offset in assignment resource information. As described above, because information about the amount of offset is included in assignment resource information, in order to reduce an equivalent number of signaling bits to the number of reduced signaling bits achieved in Embodiment 1, it is prerequisite that the bandwidths of the assignable range for the second cluster and the assignable range for the third cluster described above are made narrower than the bandwidths shown in FIG. 8.

FIG. 19 shows the number of signaling bits when three clusters are assigned by the assignable range group shown in FIG. 18. Here, the number of signaling bits is determined using equation 3 based on the same condition as the condition used when the number of signaling bits shown in FIG. 3 is determined (i.e. N_{RB}=100 [RBs], P=4, N_{Cluster}=3.)

As is clear from the comparison of FIG. 19 with FIG. 3, according to the present embodiment, even when, among the ranges configuring the assignable range group, while only some of the assignable ranges are made match the whole system band, the remaining assignable ranges are limited to a partial band of the system band, so that the amount of offset of the second assignable range (corresponding to the assignable range for the second cluster or the assignable range for the third cluster in the above description) is reported, it is possible to reduce the number of signaling bits compared to the conventional method.

As described above, according to the present embodiment, in base station apparatus 500, channel estimation section 107 estimates channel quality of a terminal subject to resource assignment, in the system band; offset setting section 501 determines the amount of offset of the second assignable range (corresponding to the assignable range for the second cluster or the assignable range for the third cluster in the above description) based on the channel quality; and scheduling section 502 adjusts the position of frequency of the second assignable range to the position the amount of offset apart from the base position, and includes information about the amount of offset in assignment resource information.

By this means, it is possible to make an assignable range match a band having good channel quality, improving the channel quality of the assignment cluster band selected in that assignable range. Therefore, because it is possible to assign a band having good channel quality to a terminal subject to resource assignment, it is possible to reduce the probability that transmission errors will occur, making it possible to improve system throughput.

Further, here, the bandwidth of the second assignable range is set smaller than ½ of the bandwidth of the whole system band. By this means, it is possible to counterbalance the amount of increase of signaling bits corresponding to the information about the amount of offset.

A case has been described with the above embodiment where processing of adjusting the position of an assignable range based on channel quality is applied to base station apparatus 100 according to Embodiment 1. However, the present invention is not limited to this, and it is possible to apply processing of adjusting the position of an assignable range based on channel quality to base station apparatus 300 according to Embodiment 2.

### Embodiment 4

A case will be described with Embodiment 4 where the position of frequency of the above-described second assignable range is changed between the first terminal subject to resource assignment and the second terminal subject to resource assignment. This information about the position of frequency is contained in assignment resource information as offset information, in the same way as in Embodiment 3.

FIG. 20 is a block diagram showing a configuration of base station apparatus 700 according to Embodiment 4 of the present invention. In FIG. 20, base station apparatus 700 includes offset setting section 701.

Offset setting section 701 sets the different amounts of offset for the first terminal subject to resource assignment and the second terminal subject to resource assignment, to each of which the resources are assigned in the same period. Specifically, offset setting section 701 holds a table showing correspondence of a plurality of terminal IDs and information about the amount of offset corresponding to each terminal ID. This terminal ID is assigned to a terminal by base station apparatus 500, for example, at the time when that terminal in the cell of base station apparatus 500 makes initial access. Then, offset setting section 701 receives as input the terminal ID of the terminal subject to resource assignment, and outputs the information about the amount of offset corresponding to this terminal ID, to scheduling section 502. Here, the amount of offset is defined by per base station or by a system as a function of a terminal ID.

FIG. 21 is a block diagram showing a configuration of terminal apparatus 800 according to Embodiment 4 of the present invention. In FIG. 21, terminal apparatus 800 includes offset setting section 801.

Offset setting section 801 performs the same processing as offset setting section 701. That is, offset setting section 801 holds a table showing correspondence of a plurality of terminal IDs and information about the amount of offset corresponding to each terminal ID. Then, offset setting section 801 receives as input the terminal ID of the terminal subject to resource assignment, and outputs the information about the amount of offset corresponding to this terminal ID, to transmission band setting section 602.

FIG. 22 shows an operation of base station apparatus 700.

As described above, offset setting section 701 outputs the information about the amount of offset corresponding to a terminal ID of a terminal subject to resource assignment, to scheduling section 502. The information about the amount of offset includes the amount of offset for the above-described second assignable range. Therefore, as shown in FIG. 22, when the assignable range for the second cluster and the assignable range for the third cluster are set as the second assignable range, information about the amount of offset contains the combination of the amounts of offset for each of the assignable range for the second cluster and the assignable range for the third cluster. That is, in FIG. 22, information about the amount of offset for terminal A contains the combination of the amounts of offset including the amount of offset of the assignable range for the second cluster being zero and the amount of offset of the assignable range for the third cluster being d₁. On the other hand, information about the amount of offset for terminal B contains the combination of the amounts of offset, including the amount of offset of the assignable range for the second cluster being d₂ and the amount of offset of the assignable range for the third cluster being d₃.

As described above, according to the present embodiment, the position of frequency of the second assignable range differs between the first terminal subject to resource assignment and the second terminal subject to resource assignment.

By this means, it is possible to disperse the positions of frequency of the assignable ranges for terminals in the cell, in the system band, so that it is possible to smooth the number of terminals that can be assigned per resource assignment unit, in the system band. By this means, it is possible to obtain constant multi-user diversity gain in the whole system band, making it possible to improve the utilization rate of the frequency resource in the cell. As a result of this, it is possible to improve system throughput.

Further, because information about the amount of offset is derived based on the terminal ID assigned to the terminal subject to resource assignment, the terminal subject to resource assignment can derive that information about the amount of offset on its own. Therefore, because it is not necessary to report the information about the amount of offset from a base station to a terminal, it is possible to reduce the number of signaling bits.

A case has been described with the above embodiment where processing of adjusting the position of the assignable range based on the different amounts of offset among a plurality of terminals subject to resource assignment, is applied to base station apparatus 100 according to Embodiment 1. However, the present invention is not limited to this, and it is possible to apply processing of adjusting the position of the assignable range based on the different amounts of offset among a plurality of terminals subject to resource assignment, to base station apparatus 300 according to Embodiment 2.

### Embodiment 5

A bandwidth of the assignable range will be described with Embodiment 5. The base station apparatus and the terminal apparatus according to the present embodiment have the same configurations as base station apparatus 100 and terminal apparatus 200 according to Embodiment 1, and hereinafter explanations will be described with reference to FIGS. 6 and 7. It is possible to employ the optimal bandwidth of the assignable range described below in base station apparatuses (300, 500, and 700) according to Embodiments 2 to 4, in addition to base station apparatus 100 according to Embodiment 1.

First, the number of signaling bits required per one cluster can be determined by equation 4.

[4]

Number of signaling bits per one cluster=┌log₂(┌N_{RB}/P┐+1C₂)┐[bits] (Equation 4)

Further, when the number of signaling bits required is the same, it is preferable that the bandwidth of the assignable range is as broad as possible, from a viewpoint of flexibility in assignment. The reason is that system throughput improves more as assignment is performed more flexibly.

FIG. 23 shows a bandwidth of the assignable range corresponding to the number of signaling bits required per cluster. As shown in FIG. 23, depending on the number of signaling bits, there might be a plurality of bandwidths of the assignable range requiring the same number of signaling bits. In that case, the broadest bandwidth out of the bandwidths of the plurality of assignable ranges is set as the bandwidth of the assignable range corresponding to that number of signaling bits. In FIG. 23, a circled dot indicates the optimal bandwidth of the assignable range for each number of signaling bits.

That is, when the target number of signaling bits is set for the second assignable range used by scheduling section 113, it is preferable that the bandwidth of the second assignable range used by scheduling section 113 matches the broadest bandwidth out of the bandwidths with which the number of signaling bits determined by equation 4 is equal to the above-described target number of signaling bits.

Further, it is possible to designate the bandwidth of the second assignable range used in scheduling section 113 as described below. That is, regarding the arbitrary number of signaling bits X (X is a natural number), N_{RB} having the broadest bandwidth out of N_{RB}s satisfying the right-hand side ≦2^{X} in above equation 4 is the optimal bandwidth of the assignable range.

FIG. 24 shows an optimal bandwidth of the second assignable range (i.e. maximum assignment bandwidth) when the number of signaling bits is the target number of signaling bits, under the same condition as when the number of signaling bits shown in FIG. 10 is determined.

As shown in FIG. 24, while the optimal bandwidth of the assignable range for the first cluster is the same bandwidth as in FIG. 10, the optimal bandwidths of the assignable ranges for the second cluster and the third cluster are sixty RBs each, which is ten RBs broader than in FIG. 10. FIG. 25 shows the assignable range group to which the optimal bandwidths shown in FIG. 24 are applied. As shown in FIG. 25, the assignable range for the second cluster and the assignable range for the third cluster partly overlaps in the center section of the system band.

As described above, according to the present embodiment, the bandwidth of the second assignable range is the broadest bandwidth out of a plurality of bandwidths with which the number of signaling bits determined using equation 4 is equal to the target number of signaling bits.

By this means, it is possible to efficiently improve the flexibility in assignment using the limited number of signaling bits, and consequently it is possible to improve system throughput efficiently.

### Other Embodiments

(1) Cases have been described with Embodiments 1 to 5 where the maximum number of clusters is three. However, the present invention is not limited to this, and it is possible to use the maximum number of clusters that is four or greater. FIGS. 26 and 27 show examples of an assignable range group when the maximum number of clusters is four and six, respectively.

(i) In FIG. 26, the assignable range for the first cluster matches the whole system band. The assignable ranges for the second cluster to the fourth cluster correspond to each of three partial bands when the system band is divided into three.

(ii) In FIG. 27, the six assignable ranges forming the assignable band group is configured to employ the so called tree structure. Specifically, the assignable ranges for the first cluster to the third cluster are the same as in Embodiment 1. The assignable ranges for the fourth cluster to the sixth cluster correspond to each of three partial bands out of four partial bands when the system band is divided into four. Here, in particular, three partial bands apart from the partial band positioned at the lowest frequency side are the assignable ranges for the fourth cluster to the sixth cluster.

Even when the above-described assignable range group is used, it is possible to maintain system throughput performance and reduce the number of signaling bits.

(2) Further, it is possible to employ the maximum number of clusters of 2. FIG. 28 shows an example of an assignable range group when the maximum number of clusters is two. Even when the above-described assignable range group is used, it is possible to maintain system throughput performance and reduce the number of signaling bits.

(3) A case has been described with Embodiment 5 where the condition in which the broadest bandwidth out of a plurality of bandwidths with which the number of signaling bits determined using equation 4 is equal to the target number of signaling bits is set as the bandwidths of the assignable ranges for the second cluster and the third cluster, is applied. However, the present invention is not limited to this, and it is possible to apply the above condition to the bandwidth of the assignable range for the first cluster.

In that case, when the target number of signaling bits for the assignable range for the first cluster is nine as shown in FIG. 24, the above-described condition is not satisfied when the bandwidth is 100 RBs. That is, the bandwidth satisfying the above-described condition when the target number of signaling bits is nine is broader than the bandwidth of the system band. Therefore, when the bandwidth of the system band is 100 RBs and the target number of signaling bits is nine, it is not possible to obtain the solution to satisfy the above-described condition.

Therefore, an optimal bandwidth of the assignable range for the first cluster when the target number of signaling bits is reduced by one to become eight, is shown in FIG. 29. That optimal bandwidth is eighty eight RBs, as shown in FIG. 29. By this means, it is possible to reduce the number of signaling bits for the assignable range for the first cluster.

FIG. 30 shows an example of arrangement of the assignable band for the first cluster when the optimal bandwidth is eighty-eight RBs. In FIG. 30, the assignable range for the first cluster is arranged in the band not including the both ends of the system band. By this means, it is possible to maintain system throughput for the same reason as described in Embodiment 1.

(4) Also, although cases have been described with the above embodiments as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-063030, filed on Mar. 16, 2009, including the specification, drawings and abstract, is incorporated herein by reference in its entirety.

### INDUSTRIAL APPLICABILITY

A scheduling apparatus and a scheduling method according to the present invention are useful for maintaining system throughput and reducing the amount of signaling of frequency resource assignment information.

1. A scheduling apparatus comprising:
a scheduler that selects a maximum of one cluster band for each of a plurality of assignable ranges set in a system band, as assignment resources for a terminal subject to resource assignment, and generates assignment resource information containing information on the selected cluster band; and
a transmission section that transmits the generated assignment resource information to the terminal subject to resource assignment;
wherein a first assignable range is the whole system band, and a second assignable range is a partial band of the system band.

2. The scheduling apparatus according to claim 1, wherein the second assignable range is a lower frequency band or a higher frequency band when the system band is divided into half.

3. The scheduling apparatus according to claim 1, wherein the second assignable range is set in a band not including both ends of the system band.

4. The scheduling apparatus according to claim 1, wherein the scheduler sets a second resource assignment unit of the second assignable range smaller than a first resource assignment unit of the first assignable range.

5. The scheduling apparatus according to claim 1, further comprising:
a channel quality estimation section that estimates channel quality of the terminal subject to resource assignment in the system band; and
an offset amount determination section that determines the amount of offset of the second assignable range based on the channel quality;
wherein the scheduler adjusts a frequency position of the second assignable range to the position the amount of offset apart from a base position, and includes information on the amount of offset into the assignment resource information.

6. The scheduling apparatus according to claim wherein a frequency position of the second assignable range differs between a first terminal subject to resource assignment and a second terminal subject to resource assignment.

7. The scheduling apparatus according to claim 1, wherein a bandwidth of the second assignable range is the broadest bandwidth out of a plurality of bandwidths N_{RB} with which the number of signaling bits determined using the following equation is equal to the target number of signaling bits.
[1]
Number of signaling bits=┌ log₂(┌N_{RB}/P┐+1C₂)┐[bits]

8. A scheduling method comprising:
selecting a maximum of one cluster band for each of a plurality of assignable ranges set in a system band, as assignment resources for a terminal subject to resource assignment; and
generating assignment resource information containing information on the selected cluster band, wherein a first assignable range is the whole system band, and a second assignable range is a partial band of the system band.
